(19) United States
(12) Patent Application Publication
(10) Pub. No.: US 2021/0282569 A1
(43) Pub. Date: Sep. 16, 2021

(54) MULTIFUNCTIONAL INTELLIGENT MATTRESS

(71) Applicant: Jiangxi Lanzhen Intelligent Technology Co., Ltd., Nanchang (CN)

(72) Inventor: Jianping MAO, Nanchang (CN)

(73) Assignee: Jiangxi Lanzhen Intelligent Technology Co., Ltd., Nanchang (CN)

(21) Appl. No.: 17/198,264

(22) Filed: Mar. 11, 2021

(30) Foreign Application Priority Data
Mar. 11, 2020 (CN) 202010164638.4

(51) Int. Cl. A47C 21/04; H02J 50/10; A47C 20/04; G05B 19/042; G10L 15/22; H04R 1/02

(52) U.S. Cl. CPC A47C 21/044; H02J 50/10; A47C 20/04; A47C 31/007; G05B 19/042; G10L 15/22; H04R 1/028; A47C 21/048

(57) ABSTRACT

A multifunctional intelligent mattress includes a functional layer and a turning device used for fixing and turning the functional layer. The functional layer has an inner layer and an outer layer. The inner layer includes a plurality of functional devices, and the outer layer is a breathable textile fabric. An external support is arranged on the edge of the outer surface of the functional layer and is used for fixing and connecting the functional layer and the turning device. The turning device includes a human body safety support layer and a turning mechanism. The human body safety support layer is used for supporting the functional layer, and a human body safety support frame is arranged on the outer surface of the human body safety support layer and is used for fixing and connecting the human body safety support layer. The functional layer has a hidden state and an exposed state.

### CROSS REFERENCE TO THE RELATED APPLICATIONS

This application is based upon and claims priority to Chinese Patent Application No. 202010164638.4, filed on Mar. 11, 2020, the entire contents of which are incorporated herein by reference.

### TECHNICAL FIELD

The present invention belongs to the field of mattresses, and particularly relates to a multifunctional intelligent mattress.

### BACKGROUND

Mattresses are used between human bodies and beds to assist users in sleeping healthily and comfortably. As generally required by the users, the mattresses should be attractive in appearance, flat in surface, dry, clean and breathable, moderate in thickness, not prone to deformation, durable, and easy to maintain. With the continuous improvement of material civilization and technologies, more and more types of mattresses are being used by people in modern society, such as spring mattresses, palm mattresses, latex mattresses, water mattresses, slope spine-protection mattresses, air mattresses and magnetic mattresses, wherein the spring mattresses account for a large proportion all these mattresses.

To adapt to different application occasions and satisfy different demands of users, higher requirements have been put forward to the heating function, ventilation function, dehumidification function, physiotherapy function and sterilization and mite-killing function of the mattresses. The mattresses are professionally evaluated generally in the aspect of functionality, comfort and safety in use, and meanwhile, the pressure distribution, stability, shear force/frictional force, temperature, humidity, durability, infection source control, mite prevention and killing, and cleaning of the mattresses should also be taken into consideration, comprehensively. However, existing mattresses cannot adapt to different application occasions or satisfy diversified requirements of users due to their simplex functions, and have potential health risks.

### SUMMARY

The objective of the present invention is to solve the above-mentioned problems by providing a multifunction intelligent mattress, which has a heating/cooling function, an air draft/blow function, a health-care function as well as a sterilization and mite-killing function, is high in intelligence degree, and is provided with a safety recognition module, thus satisfying using requirements.

The technical solution adopted by the present invention to fulfill the aforesaid objective is as follows:

A multifunctional intelligent mattress comprises a functional layer and a turning device used for fixing and turning the functional layer, wherein the functional layer has an inner layer and an outer layer, the inner layer comprises a plurality of functional devices, and the outer layer is a breathable textile fabric; an external support is arranged on the edge of the outer surface of the functional layer and is used for fixing and connecting the functional layer and the turning device; the turning device comprises a human body safety support layer and a turning mechanism, the human body safety support layer is used for supporting the functional layer, and a human body safety support frame is arranged on the outer surface of the human body safety support layer and is used for fixing and connecting the human body safety support layer; the functional layer has two states, namely a hidden state and an exposed state; in the exposed state, the functional layer is located on the upper surface of the human body safety support layer, and the front side of the functional layer faces upwards; in the hidden state, the functional layer is located below the human body safety support layer or on the upper surface of the human body safety support layer, and the front side of the functional layer faces downwards; the functional layer is turned by the turning mechanism to be switched to the hidden state or the exposed state; the turning mechanism is a turning slide-rail structure or a turning support structure; and the intelligent mattress further comprises a control system and a power supply system, wherein the control system is used for controlling the intelligent mattress according to an external instruction and comprises controllers and an operating terminal, the controllers include a master controller and sub-controllers, the master controller is in signal communication with the sub-controllers disposed in the functional layer and is arranged in the operating terminal, the operating terminal is used for receiving an external control instruction, and the power supply system is used for supplying power to the intelligent mattress.

Preferably, the turning slide-rail structure comprises two parallel sets of slideways. Each set of slideways includes a main slideway, a plurality of sub-slideways and a bottom slideway, wherein a first sub-slideway, a second sub-slideway, . . . , are sequentially arranged below the main slideway, the bottom slideway is located at the bottom, the human body safety support layer is fixed between the lower surface of the main slideway and the upper surface of the first sub-slideway, the main slideway and the sub-slideways are located on the same vertical plane and are horizontal, two ends of the main slideway are aligned with two ends of each sub-slideway, the head ends of the main slideway and the sub-slideways are connected by means of connecting slideways, sealing devices are arranged at the tail ends opposite to the head ends, and the connecting slideways have a closed state and an open state; when the connecting slideways are closed, the main slideway is connected to the sub-slideways; and when the connecting slideways are opened, the main slideway is disconnected from the sub-slideways; and

Sliding wheels matched with the slideways are arranged on the external support, and the functional layer is able to slide and turn along the slideways by means of the sliding wheels; and the functional layer is positioned between two sub-slideways or between the last sub-slideway and the bottom slideway, and is able to slide and turn along the slideways to be switched to the hidden state or the exposed state.

Preferably, the turning support structure comprises a support arm which is a linear support arm or an L-shaped support arm, wherein the head end of the support arm is pivoted to the edge of the human body safety support frame, and the tail end, opposite to the head end, of the support arm is pivoted to the external support;

The support arm is able to turn, with the head end of the support arm as an axis, by 90° or 180° in a direction perpendicular to the edge, to which the head end of the support arm is connected, of the human body safety support frame; or

The support arm allows the functional layer to turn, with the tail end of the support arm as an axis, by 180° in a direction perpendicular or parallel to the edge, to which the head end of the support arm is connected, of the human body safety support frame.

Preferably, the functional layer includes a single functional layer and/or a complex functional layer; the single functional layer is an induction layer, a heating layer, a fan layer or a pneumatic buffer layer; a temperature sensor and a pressure sensor are arranged in the induction layer and are electrically connected to a first sub-controller; a heating device is arranged in the heating layer and is electrically connected to a second sub-controller; an exhaust fan and a convection fan are arranged in the fan layer and are electrically connected to a third sub-controller; a buffer spring is arranged in the pneumatic buffer layer, and both the interior and the exterior of the pneumatic buffer layer are breathable;

The complex functional layer is a cooling-heating panel layer, a multifunctional pneumatic layer, a multifunctional cooling-heating layer, or a multifunctional health-care layer, wherein a semiconductor cooling-heating panel and a cooling fan are arranged in the cooling-heating panel layer and are electrically connected to a fourth sub-controller, the semiconductor cooling-heating panel has a heating face and a cooling face, and the cooling fan is arranged on one side of the heating face of the semiconductor cooling-heating panel; the multifunctional pneumatic layer comprises the fan layer and an air amplification layer arranged over the fan layer, the periphery of the air multiplication layer is sealed, the air multiplication layer has an upper layer, a middle layer and a bottom layer, the upper layer is formed with multiple circular concave vortex air holes, the middle layer is of a hollow structure and is internally provided with a support spring, and the bottom layer is impermeable and has multiple fan ports allowing an airflow from the fan layer to flow through; the multifunctional cooling-heating layer comprises the heating layer and the multifunctional pneumatic layer; the multifunctional health-care layer is provided with a graphene physiotherapy lamella or a massage lamella, which is electrically connected to a fifth sub-controller;

The functional layers can be used in combination with a plurality of independent devices, which include a humid air supply device and/or a sterilization device and are arranged on one side of the human body safety support frame or the external support, and the humid air supply device or the sterilization device is in signal communication with the master controller;

The functional layers can be used in combination, wherein the pneumatic buffer layer and the induction layer can be used in combination with the multifunctional cooling-heating layer, the multifunctional health-care layer, or the cooling-heating panel layer;

The multifunctional pneumatic layer can be used in combination with the cooling-heating panel layer;

The multifunctional cooling-heating layer or the multifunctional pneumatic layer can be used in combination with the humid air supply device; and

The cooling-heating panel layer can be used in combination with the heating layer.

More preferably, the exhaust fan is used for extracting air from above and discharging the air around the exhaust fan, or extracting air around the exhaust fan and discharging the air upwards; the convection fan is used for extracting air from above and discharging the air downwards, or extracting air from below and discharging the air upwards; the exhaust fan and the convection fan are arranged in a staggered manner, and air passages are formed in the periphery of the exhaust fan and extend to side faces of the fan layer.

More preferably, a plurality of semiconductor cooling-heating panels are arranged in the cooling-heating panel layer, wherein each semiconductor cooling-heating panel has a heating face and a cooling face, a cooling fan is arranged on one side of the heating face of each semiconductor cooling-heating panel, the heating faces of the semiconductor cooling-heating panels all face the upper surface or the lower surface of the cooling-heating panel layer, and the cooling faces of the semiconductor cooling-heating panels all face the other surface of the cooling-heating panel layer.

More preferably, the humid air supply device comprises a liquid container, a semiconductor cooling-heating panel and an air transport pipeline, wherein the semiconductor cooling-heating panel is in signal communication with the master controller; liquid is contained in the liquid container, an outlet is formed in one end of the liquid container, and the semiconductor cooling-heating panel encircles the liquid container; the semiconductor cooling-heating panel has a heating face and a cooling face which are arranged separately, and a cooling fan is arranged on one side of the heating face; and the air transport pipeline has an end connected to the outlet and an end divided into a plurality of branch pipelines which are connected to the air passages of the fan layer, the multifunctional cooling-heating layer, or the multifunctional pneumatic layer.

More preferably, the humid air supply device further comprises a water level sensor and a temperature sensor which are in signal communication with the master controller, wherein the water level sensor is used for detecting water level information of the liquid in the liquid container, and the temperature sensor is used for detecting temperature information of the liquid in the liquid container and an airflow generated.

More preferably, a temperature isolation device is arranged in the induction layer, is located below a sensing part of the temperature sensor, and is used for isolating the sensing part, located above the temperature isolation device, of the temperature sensor from an airflow below the temperature isolation device.

More preferably, a through hole is formed in the temperature isolation device, and the sensing part of the temperature sensor extends to the upper surface of the induction layer via the through hole.

More preferably, the functional layers having electrical devices therein are provided with safety devices, which are arranged on the outer surfaces of the inner layers of the functional layers and are used for supporting and protecting the devices in the functional layers so as to prevent the functional layers against damage under pressure.

More preferably, the safety devices are support net structures.

More preferably, the master controller is electrically or wirelessly connected to the sub-controllers to receive control signals from the sub-controllers and controls the devices in the functional layers.

More preferably, one or more of Bluetooth modules, 2.4G modules, mobile signal modules and WIFI signal modules, which are adaptively connected, are arranged in the master controller and the sub-controllers.

More preferably, the operating terminal is one or more of a mobile phone, a computer mobile terminal, a wireless remote controller, a touch screen, a wireless headset and a wireless watch.

More preferably, in the case of being wirelessly connected to the functional layer, the operating terminal comprises a microphone device, a loudspeaker device and a displayer, wherein the microphone device is provided with a voice control chip and is used for receiving external voice control instructions, the loudspeaker device is used for playing voice messages, and the displayer is used for displaying the operating state of the intelligent mattress.

More preferably, the induction layer further comprises a humidity sensor, which is arranged on the upper surface of the induction layer and is electrically connected to the first sub-controller.

More preferably, the first sub-controller comprises a safety recognition module, which is used for determining whether or not a user of the intelligent mattress is in a safe condition by means of the temperature sensor and the humidity sensor; the temperature sensor is used for detecting temperature data in real time and determining whether or not the temperature data is within a safety range; and the humidity sensor is used for detecting humidity data in real time and determining whether or not the humidity data is within a safety range.

More preferably, the first sub-controller comprises a self-start recognition module, which includes a pressure recognition module and an infrared induction module; the pressure recognition module is automatically started when determining that the user is close to or is located on the intelligent mattress according to pressure data detected in real time by the pressure sensor in the induction layer and is automatically stopped when determining that the user leaves the intelligent mattress; the infrared induction module comprises an infrared sensor, which is arranged on one side of the induction layer and is electrically connected to the first sub-controller; and the infrared induction module is automatically started when determining that the user is close to or is located on the intelligent mattress according to data detected in real time by the infrared sensor and is automatically stopped when determining that the user leaves the intelligent mattress.

More preferably, a vibrating device and a timing device are arranged in the pneumatic buffer layer and are electrically controlled to a sixth sub-controller, and the sixth controller comprises an intelligent wake-up module which is used for controlling the vibrating device to vibrate at a time set by the timing device.

More preferably, the power supply system comprises a power supply device arranged on the side face of the human body safety support device and is one or more of a battery system, an AC power supply system, a solar power supply system and an adsorptive human body safety magnetic-induction power supply system.

More preferably, the solar power supply system comprises a solar power supply panel, which is electrically connected to a power unit and is arranged in a groove in the side face of the intelligent mattress.

More preferably, the adsorptive human body safety magnetic-induction power supply system comprises a transmitting magnetic-induction power supply device and an incoming magnetic-induction power supply device, wherein the incoming magnetic-induction power supply device is arranged on the side face of the functional layer; the transmitting magnetic-induction power supply device is arranged on the human body safety support layer, corresponds to the incoming magnetic-induction power supply device, and comprises a transmitting induction zone with a transmitting coil, and the transmitting induction zone is electrically connected to a power supply through a current step-down device; the incoming magnetic-induction power supply device comprises an incoming induction zone with an incoming coil, and the incoming induction zone supplies power to the electrical devices in the functional layer by means of a power transmission line; and magnetic adsorption zones are arranged around the transmitting induction zone and the incoming induction zone, and magnet devices are arranged in the magnetic adsorption zones.

More preferably, the functional layers are fixedly connected by means of hook-and-loop fasteners, magnetic buckles, or hidden buckles, wherein the magnetic buckles are magnets, and the functional layers are attracted together by means of the magnets.

Compared with the prior art, the present invention has the following beneficial effects:

(1) The multifunctional intelligent mattress of the present invention comprises multiple functional layers, thus meeting the requirements for cooling/heating, air blow/draft, daily physiotherapy, humidification, and sterilization and mite-killing in use; the functional layers can be turned by the turning device to be switched and can be used independently or in combination to fulfill different functions and to satisfy user's requirements more easily and comprehensively; and the multifunctional intelligent mattress is easy to popularize.

(2) Compared with the mattresses with only one function on the market, the multifunctional intelligent mattress of the present invention has multiple functions such as air blow and draft functions, thus being suitable for users with different demands and preferences; and the air heating and supply function can fulfill dehumidification and drying and is conducive to hot compress and blood circulation.

(3) The fan layer of the multifunctional intelligent mattress of the present invention is provided with the air passages to form airflow zones, so that smooth air circulation is effectively realized, and the problems of backflow and noise caused by airflow collisions resulting from poor air circulation are effectively solved.

(4) When the multifunctional intelligent mattress of the present invention is used, a liquid aromatic can be added into the liquid container of the humid air supply device to fulfill an aromatherapy function, an air purification function and a refreshing function.

(5) The multifunctional intelligent mattress of the present invention is high in intelligence degree; and the operating terminal is a remote control device matched with the intelligent mattress or a mobile terminal equipped with an app matched with the intelligent mattress, and thus, the intelligent mattress can be directly controlled by voice, by Bluetooth or by the operating terminal easily and flexibly.

(6) The multifunctional intelligent mattress of the present invention has extremely broad application prospects, for example, the intelligent mattresses can be applied to sofas, chairs (seats, back-rest chairs, automobile seats, etc.), mattresses, backpacks, cushions, back cushions and any other products with the above-mentioned functional requirements, and can also be applied to the field of garments with heating/cooling requirements.

### BRIEF DESCRIPTION OF THE DRAWINGS

FIG. 1 is a structural diagram of a functional layer of a multifunctional intelligent mattress in Embodiment 1.

FIG. 2 is a structural diagram of an external support of the multifunction intelligent mattress in Embodiment 1.

FIG. 3 is a structural diagram of a human body safety support frame of the multifunctional intelligent mattress in Embodiment 1.

FIG. 4 is a structural diagram of a turning slide-rail structure of the multifunctional intelligent mattress in Embodiment 1.

FIG. 5 is a schematic diagram of the turning slide-rail structure, with a human body safety support layer, of the multifunctional intelligent mattress in Embodiment 1.

FIG. 6 is a schematic diagram of sliding wheels on the functional layer of the multifunctional intelligent mattress in Embodiment 1.

FIG. 7 is a sectional view of one sliding wheel in a slideway of the multifunctional intelligent mattress in Embodiment 1.

FIG. 8 is a schematic diagram of the serial numbers of the sliding wheels on the functional layer of the multifunctional intelligent mattress in Embodiment 1.

FIG. 9 is a structural diagram of an induction layer of the multifunctional intelligent mattress in Embodiment 1.

FIG. 10 is a structural diagram of a heating layer of the multifunctional intelligent mattress in Embodiment 1.

FIG. 11 is a structural diagram of a fan layer of the multifunctional intelligent mattress in Embodiment 1.

FIG. 12 is a structural diagram of a pneumatic buffer layer of the multifunctional intelligent mattress in Embodiment 1.

FIG. 13 is a structural diagram of a cooling-heating panel layer of the multifunctional intelligent mattress in Embodiment 1.

FIG. 14 is an exploded view of a multifunctional pneumatic layer of the multifunctional intelligent mattress in Embodiment 1.

FIG. 15 is a partial structural diagram of air holes of an air multiplication layer of the multifunctional intelligent mattress in Embodiment 1.

FIG. 16 is an exploded view of a multifunctional cooling-heating layer of the multifunctional intelligent mattress in Embodiment 1.

FIG. 17 is a structural diagram of a multifunctional health-care layer of the multifunctional intelligent mattress in Embodiment 1.

FIG. 18 is a structural diagram of a humid air supply device of the multifunctional intelligent mattress in Embodiment 1.

FIG. 19 is a structural diagram of an adsorptive human body safety magnetic-induction power supply system of the multifunctional intelligent mattress in Embodiment 1.

FIG. 20 is a structural diagram of a linear support arm of the multifunctional intelligent mattress in Embodiment 2.

FIG. 21 is a turning diagram of the linear support arm of the multifunctional intelligent mattress in Embodiment 2.

FIG. 22 is another structural diagram of the linear support arm of the multifunctional intelligent mattress in Embodiment 2.

FIG. 23 is a structural diagram of an L-shaped support arm of the multifunctional intelligent mattress in Embodiment 2.

FIG. 24 is a turning diagram of the L-shaped support arm of the multifunctional intelligent mattress in Embodiment 2.

FIG. 25 is another structural diagram of the L-shaped support arm of the multifunctional intelligent mattress in Embodiment 2.

Reference signs: 1, functional layer; 2, inner layer; 3, outer layer; 4, external support; 5, human body safety support layer; 6, human body safety support frame; 7, main slideway; 8, first sub-slideway; 9, second sub-slideway; 10, bottom slideway; 11, sealing device; 12, sliding wheel; 13, sliding wheel connecting rod; 14, sliding wheel buckle; 15, sliding wheel groove; 16, end cover; 17, first connecting slideway; 18, second connecting slideway; 19, third connecting slideway; 20, fourth connecting slideway; 21, first sliding wheel; 22, second sliding wheel; 23, third sliding wheel; 24, fourth sliding wheel; 25, fifth sliding wheel; 26, sixth sliding wheel; 27, seventh sliding wheel; 28, eighth sliding wheel; 29, pneumatic buffer layer; 291, vibrating device; 292, timing device; 30, fan layer; 31, exhaust fan; 32, convection fan; 33, air passage; 34, support spring; 35, multifunctional pneumatic layer; 36, air multiplication layer; 361, upper layer; 3611, air hole; 362, middle layer; 363, bottom layer; 37, fan port; 38, induction layer; 381, pressure sensor; 382, temperature sensor; 3821, sensing part; 383, infrared sensor; 39, multifunctional cooling-heating layer; 40, heating layer; 401, heating device; 402, air vent; 41, humid air supply device; 42, liquid container; 43, air transport pipeline; 44, outlet; 45, semiconductor cooling-heating panel; 451, cooling face; 452, heating face; 46, temperature isolation device; 47, cooling fan; 48, cooling-heating panel layer; 49, transmitting magnetic-induction power supply device; 50, incoming magnetic-induction power supply device; 51, transmitting induction zone; 52, current step-down device; 53, power supply; 54, incoming induction zone; 55, power transmission line; 56, magnetic adsorption zone; 57, linear support arm; 58, L-shaped support arm; 59, head end of support arm; 60, tail end of support arm; 61, multifunction health-care layer; 611, graphene physiotherapy lamella; 612, massage lamella.

### DETAILED DESCRIPTION OF THE EMBODIMENTS

For the sake of a better understanding of the present invention, the contents of the present invention are further expounded below in conjunction with the accompanying drawings and embodiments. Clearly, the present invention is not limited to the following embodiments.

It should be noted that in the description of the present invention, the terms such as “first” and “second” in the description, claims and accompanying drawings are used to distinguish similar objects and do not indicate a specific sequence or a priority order. It should be understood that these terms can be interchanged under appropriate circumferences to facilitate the description of the embodiments of the present invention. Moreover, the terms “comprise”, “provided with” and any transformations thereof are intended to refer to non-exclusive inclusion. For example, a process, method, a system, product or device comprising a series of steps or units is not limited to the steps or units that are specifically listed, and may also include other steps or units that are not specifically listed, or include inherent steps or units of the process, method, product or device.

It should be understood that in the description of the present invention, the terms such as “upper”, “lower”, “top”, “bottom”, “inner” and “outer” are used to indicate directional or positional relations based on the accompanying drawings to facilitate and simplify the description of the present invention, do not indicate or imply that the components referred to must have specific directions or must be configured or operated in specific directions, and thus, should not be interpreted as limitations of the present invention.

### Embodiment 1

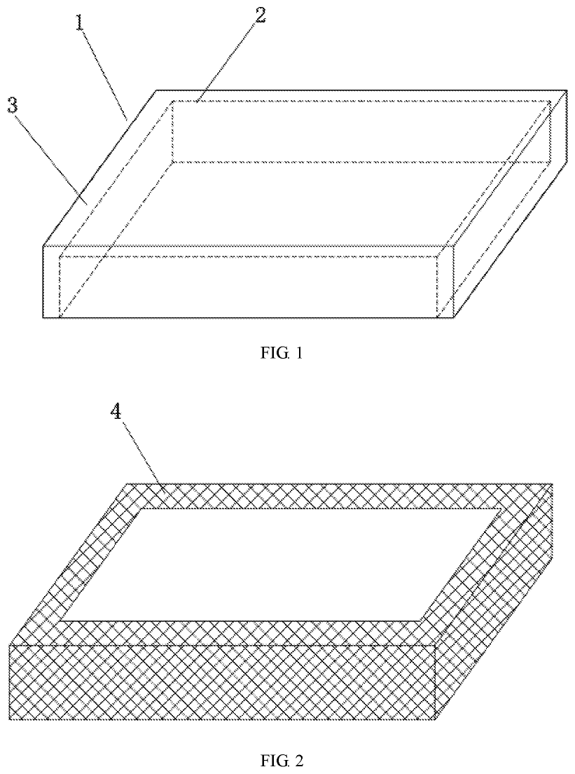

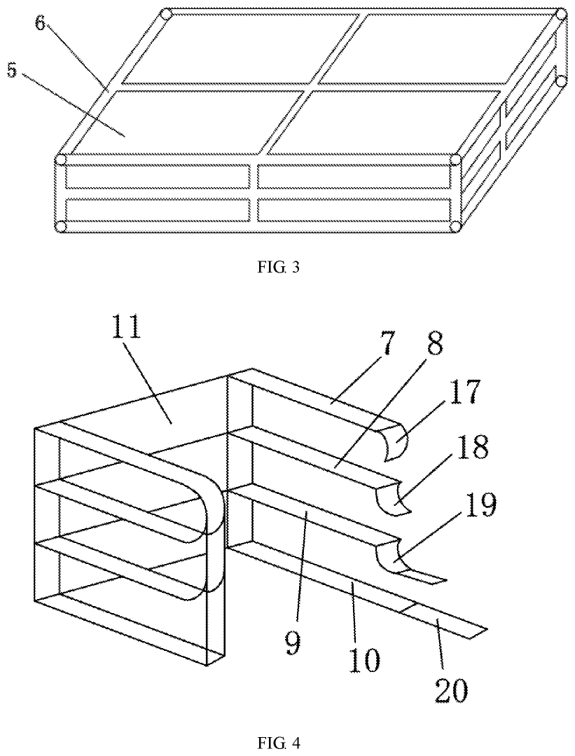

As shown in FIG. 1 to FIG. 3, a multifunctional intelligent mattress comprises a functional layer 1 and a turning device used for fixing and turning the functional layer, wherein the functional layer 1 has an inner layer 2 and an outer layer 3, the inner layer 2 comprises a plurality of functional devices, and the outer layer 3 is a breathable textile fabric; an external support 4 is arranged on the edge of the outer surface of the functional layer and is used for fixing and connecting the functional layer 1 and the turning device; the turning device comprises a human body safety support layer 5 and a turning mechanism, the human body safety support layer 5 is used for supporting the functional layer 1, and a human body safety support frame 6 is arranged on the outer surface of the human body safety support layer 5 and is used for fixing and connecting the human body safety support layer 5; the functional layer 1 has two states, namely a hidden state and an exposed state, wherein in the exposed state, the functional layer 1 is located on the upper surface of the human body safety support layer 5 and the front side of the functional layer 1 faces upwards; in the hidden state, the functional layer 1 is located below the human body safety support layer 5 or on the upper surface of the human body safety support layer 5 and the front side of the functional layer faces downwards; and the turning mechanism is used for turning the functional layer 1 to switch the functional layer into the hidden state or the exposed state, and is a turning slide-rail structure or a turning support structure. The intelligent mattress further comprises a control system and a power supply system, wherein the control system is used for controlling the intelligent mattress according to an external instruction and comprises controllers and an operating terminal, the controllers include a master controller and sub-controllers, the master controller is in signal communication with the sub-controllers disposed in the functional layer 1 and is arranged in the operating terminal, and the operating terminal used for receiving the external instruction; and the power supply system is used for supplying power to the intelligent mattress. Wherein, the external support 4 and the human body safety support frame 6 are support rail structures or support net structures. Specifically:

As shown in FIG. 4 and FIG. 5, in this embodiment, the turning mechanism is a turning slide-rail structure and comprises two parallel sets of slideways. Each set of slideways includes a main slideway 7, a plurality of sub-slideways and a bottom slideway 10, wherein a first sub-slideway 8, a second sub-slideway 9, . . . , are sequentially arranged below the main slideway 7, the bottom slideway 10 is located at the bottom, and the human body safety support layer 5 is fixed between the lower surface of the main slideway 7 and the upper surface of the first sub-slideway 8; the main slideway 7 and the sub-slideways are located on the same vertical plane and are horizontal, the two ends of the main slideway 7 are aligned with the two ends of each sub-slideway, head ends of the main slideway 7 and the sub-slideways are connected by means of connecting slideways, and sealing devices 11 are arranged at tail ends, opposite to the head ends, of the slideways; the connecting slideways have a closed state and an open state; when the connecting slideways are closed, the main slideway 7 is connected to the sub-slideways; and when the connecting slideways are opened, the main slideway 7 is disconnected from the sub-slideways. In this embodiment, slide rails are arranged on the upper sides and lower sides of the main slideway 7 and the sub-slideways, and a slide rail is arranged on the upper surface of the bottom slideway 10.

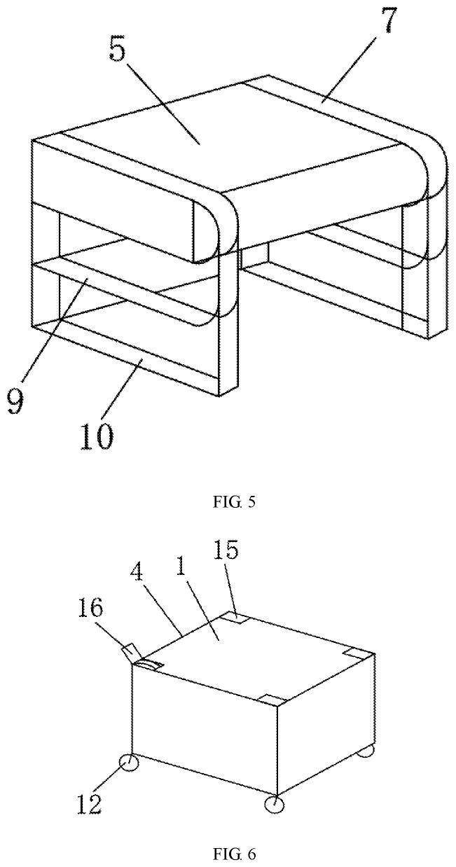

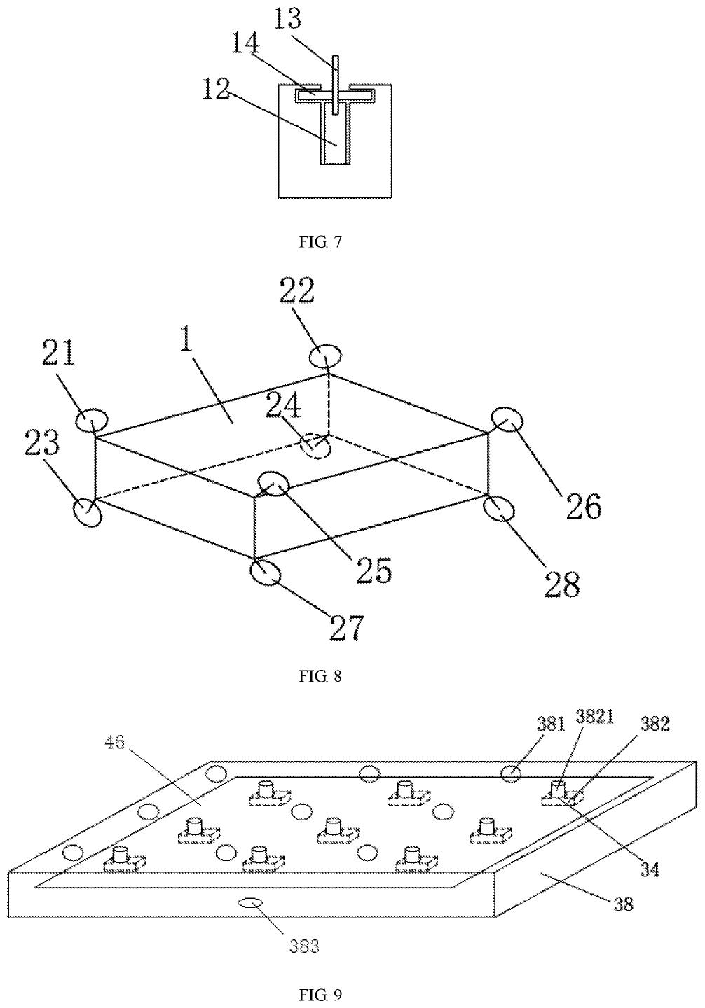

As shown in FIG. 6 and FIG. 7, sliding wheels 12 matched with the slideways are arranged on the external support 4, and the functional layer 1 slides and turns along the slideways by means of the sliding wheels 12; and the functional layer 1 may be arranged between two sub-slideways or between the last sub-slideway and the bottom slideway 10 and can slide and turn along the slideways to be switched into the hidden state or the exposed state.

Wherein, the sliding wheels 12 are fixed to the edge of the external support 4 by means of sliding wheel connecting rods 13. For example, in the case of eight sliding wheels 12, the eight sliding wheels 12 are respectively fixed to eight corners of the external support. The sliding wheels 12 are preferably movable and steerable universal wheels. To prevent the sliding wheels 12 from falling in the sliding process, sliding wheel buckles 14 are arranged on the sliding wheel connecting rods 13, the sliding wheel buckles 14 can rotate, or stretch or retreat to clamp the sliding wheels 12 in the slide rails so as to prevent the sliding wheels 12 from sliding out of the slideways, and the sliding wheels 12 can also be easily moved out of the slideways. To prevent the functional layer 1 from being affected by the sliding wheels 12 in use, sliding wheel grooves 15 are formed in positions, where the sliding wheels are fixed, of the external support 4; when the sliding wheels 12 are not used, the sliding wheel connecting rods 13 can be stretched or retreated to receive the sliding wheels in the sliding wheel grooves 15; and end covers 16 are arranged over the sliding wheel grooves 15 and can be closed to keep the surface of the external support 4 flat and smooth.

When the main slideway 7 is connected to the sub-slideways, the functional layer 1 can turn; or, the functional layer 1 directly slides through the joints of the main slideway 7 and the sub-slideways. The sealing devices 11 arranged at the tail ends opposite to the head ends may be baffles to prevent the functional layer 1 from sliding out of the slide rails.

For example, as shown in FIG. 4 and FIG. 8, the first sub-slideway 8, the second sub-slideway 9 and the bottom slideway 10 are sequentially arranged below the main slideway 7 from top to bottom, a first connecting slideway 17 is arranged at the head end of the main slideway 7, a second connecting slideway 18 is arranged at the head end of the first sub-slideway 8, a third connecting slideway 19 is arranged at the head end of the second sub-slideway 9, and a fourth connecting slideway 20 is arranged on the bottom slideway 10; the first connecting slideway 17 and the second connecting slideway 18 are arc, and when the first connecting slideway 17 and the second connecting slideway 18 are both closed, the main slideway 7 is connected to the first sub-slideway 8; the third connecting slideway 19 is formed by an arc track and a straight track, and when the first connecting slideway 17 and the third connecting slideway 19 are both closed, the main slideway 7 is connected to the second sub-slideway 9; and the fourth connecting slideway 20 is preferably a linear slideway which is easy to close and open.

The human body safety support layer 5 is arranged between the main slideways 7 and the first sub-slideways 8 and is used for supporting the functional layer 1 over the human body safety support layer 5. Suppose the functional layer 1 in the figure is initially located between the first sub-slideways 8 and the second sub-slideways 9, the functional layer 1 is in the hidden state at this moment. When the functional layer 1 needs to be turned to be above the human body safety support layer 5, first of all, the third connecting slideways 19 are opened, the first connecting slideways 17 and the second connecting slideways 18 are closed to allow the functional layer 1 to slide outwards towards the head ends of the first sub-slideways 8, at this moment, a fifth sliding wheel 25, a sixth sliding wheel 26, a seventh sliding wheel 27 and an eighth sliding wheel 28 slide out of the main slideways 7 and the first sub-slideways 8, a first sliding wheel 21 and a second sliding wheel 22 slide on the lower surfaces of the first sub-slideways 8, and a third sliding wheel 23 and a fourth sliding wheel 24 slide on the upper surfaces of the second sub-slideways 9. When the first sliding wheel 21 and the second sliding wheel 22 are about to slide out of the lower surfaces of the first sub-slideways 8, the functional layer 1 is lifted to allow the first sliding wheel 21 and the second sliding wheel 22 to sequentially slide into the second connecting slideways 18 and the first connecting slideways 17, the third sliding wheel 23 and the fourth sliding wheel 24 depart from the slideways, and at this moment, the functional layer 1 can be turned according to the following two solutions:

Solution 1: after the first sliding wheel 21 and the second sliding wheel 22 slide onto the upper surfaces of the main slideways 7 along the first connecting slideways 17, the functional layer 1 is turned, with a connecting line between the first sliding wheel 21 and the second sliding wheel 22 as an axis, towards the tail ends of the main slideways 7 to allow the fifth sliding wheel 25 and the sixth sliding wheel 26 to get onto the upper surfaces of the main slideways 7, and at this moment, the position of the functional layer 1 is adjusted until the functional layer 1 is located over the human body safety support layer 5.

Solution 2: after the first sliding wheel 21 and the second sliding wheel 22 slide onto the upper surfaces of the main slideways 7 along the first connecting slideways 17, the functional layer 1 is pushed to be perpendicular to the human body safety support layer 5, and at this moment, the first sliding wheel 21, the second sliding wheel 22, the third sliding wheel 23 and the fourth sliding wheel 24 are all located on the upper surfaces of the main slideways 7; afterwards, the functional layer 1 is turned, with a connecting line between the third sliding wheel 23 and the fourth sliding wheel 24 as an axis, towards the head ends of the main slideways 7 until the functional layer 1 is parallel to the human body safety support layer 5, at this moment, the first sliding wheel 21 and the second sliding wheel 22 depart from the slideways, and the third sliding wheel 23 and the fourth sliding wheel 24 are located on the upper surfaces of the main slideways 7; and finally, the functional layer 1 is pushed towards the tail ends of the main slideways 7 until the third sliding wheel 23, the fourth sliding wheel 24, the seventh sliding wheel 27 and the eighth sliding wheel 28 are all located on the upper surfaces of the main slideways 7, and at this moment, the functional layer 1 is located over the human body safety support layer.

By adoption of solution 1, the functional layer 1 is turned to interchange the front side and the back side of the functional layer 1, that is, when the functional layer 1 is in the hidden state, the upper surface is side A, and the lower surface of side B; and after the functional layer 1 is turned to be switched into the exposed state, the upper surface is side B, and the lower surface is side A. By adoption of solution 2, the functional layer 1 is turned without exchanging the front side and the back side, that is, when the functional layer 1 is in the hidden state, the upper surface is side A, and the lower surface is side B; and after the functional layer 1 is turned to be switched into the exposed state, the upper surface is still side A, and the lower surface is still side B.

On the basis of the two turning solutions, the back sides of two functional layers 1 can be connected and fixed to integrate the two functional layers into a combined functional layer, so that the turning slide-rail structure can accommodate more functional layers 1; and the functional layer 1 to be used can be changed by turning.

The functional layer 1 of the present invention is a single functional layer and/or a complex functional layer, wherein the single functional layer is an induction layer 38, a heating layer 40, a fan layer 30, or a pneumatic buffer layer 29; the complex functional layer is a cooling-heating panel layer 48, a multifunctional pneumatic layer 35, a multifunctional cooling-heating layer 39, or a multifunctional health-care layer 61; the functional layers 1 can be combined for use and can also be used in combination with external independent devices. Specifically:

Single Functional Layer:

(1) Induction layer 38: as shown in FIG. 9, temperature sensors 382 and pressure sensors 381 are arranged in the induction layer 38 and are electrically connected to a first sub-controller, the temperature sensors 382 are used for detecting temperature data above the induction layer 38 in real time, and the pressure sensors 381 are used for detecting pressure data above the induction layer 38 in real time. The pressure sensors 381 may be thin-film sensors and are arranged on the upper surface of the induction layer 38.

To ensure that the temperature detected by the temperature sensors 382 is more accurate, a temperature isolation device 46 is arranged in the induction layer 38, is disposed below sensing parts 3821 of the temperature sensors 382, and is used for isolating the sensing parts 3821, above the temperature isolation device 46, of the temperature sensors from an airflow below the temperature isolation device 46.

To be specific, the temperature isolation device 46 has through holes, and the sensing parts 3821 of the temperature sensors 382 extend to the upper surface of the induction layer 38 via the through holes.

The induction layer 38 further comprises humidity sensors which are disposed on the upper surface of the induction layer 38, wherein the humidity sensors can be arranged with reference to the pressure sensors 381 and are staggered with the pressure sensors 381. The humidity sensors are also electrically connected to the first sub-controller. The first sub-controller comprises a safety recognition module, which is used for determining whether or not a user of the intelligent mattress is in a safe condition by means of the temperature sensors 382 and the humidity sensors. The temperature sensors 382 are used for detecting temperature data in real time and determining whether or not the temperature data is within a safety range, and the humidity sensors are used for detecting humidity data in real time and determining whether or not the humidity data is within a safety range. For example, when the mattress is used by infants or the elderly, whether or not the infants or the elderly wet the bed and whether or not the body temperature of the infants or the elderly is normal can be determined by means of the safety recognition module.

The first sub-controller comprises a self-start recognition module, which comprises a pressure recognition module and an infrared induction module, wherein the pressure recognition module is automatically started when determining that a user is close to or is located on the intelligent mattress according to the pressure data detected in real time by the pressure sensors 381 in the induction layer 38, and is automatically stopped when determining that the user leaves the intelligent mattress; the infrared induction module comprises an infrared sensor 383, which is arranged on one side of the induction layer 38 and is electrically connected to the first sub-controller; and the infrared induction module is automatically started when determining that the user is close to or is located on the intelligent mattress according to data detected in real time by the infrared sensor, and is automatically stopped when determining that the user leaves the intelligent mattress.

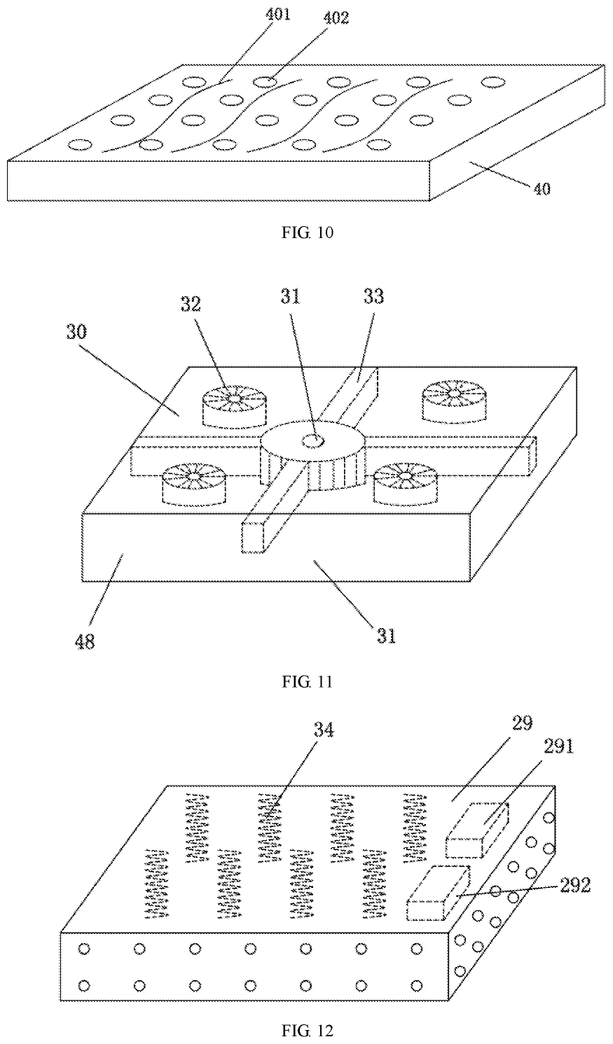

(2) Heating layer 40: as shown in FIG. 10, heating devices 401 are arranged in the heating layer 40 and are electrically connected to a second sub-controller. The heating devices 401 may be heating wires or heating plates. The heating layer 40 may be divided into an upper layer and a lower layer, wherein the lower layer of the heating layer 40 is breathable and is formed with air vents 402, and the heating devices 401 are arranged on the upper layer without blocking the air vents 402.

(3) Fan layer 30: as shown in FIG. 11, the fan layer 30 comprises a plurality of exhaust fans 31 and convection fans 32, wherein the exhaust fans 31 and the convection fans 32 are electrically connected to a third sub-controller, and the convection fans 32 extract air from above and discharge the air downwards; or, the convection fans 32 extract air from below and discharge the air upwards.

The exhaust fans 31 extract air from above and discharge the air all around the exhaust fans 31; or, the exhaust fans 31 extract air all around the exhaust fans 31 and discharge the air upwards. In this embodiment, the exhaust fans 31 and the convection fans 32 are arranged in a staggered manner, and four air outlets are formed in the periphery of each exhaust fan 31 and extend to the side faces of the fan layer 30 via air passages 33.

The air passages 33 can effectively fulfill smooth air circulation and can effectively solve the problems of backflow and noise caused by air collisions resulting from poor air circulation.

The fan layer 30 has an air blow function as well as an air draft function, and an air blow mode or an air draft mode can be flexibly selected according to the application scenario and the proprioception of users.

The fans in the fan layer 30 can be controlled synchronously or independently to implement different operating solutions and to control the air blow/draft mode. The air blow/draft mode can be controlled by changing the rotation direction of fan impellers or by turning the fan layer.

(4) Pneumatic buffer layer 29: as shown in FIG. 12, support springs 34 are arranged in the pneumatic buffer layer 29, and both the interior and the exterior of the pneumatic buffer layer 29 are breathable.

A vibrating device 291 and a timing device 292 are also arranged in the pneumatic buffer layer 29 and are electrically connected to a sixth sub-controller, and the sixth sub-controller comprises an intelligent wake-up module which is used for controlling the vibrating device 291 to vibrate at a time set by the timing device 292. The vibrating device 291 is arranged on the head or the foot of the pneumatic buffer layer 29.

Complex Functional Layer:

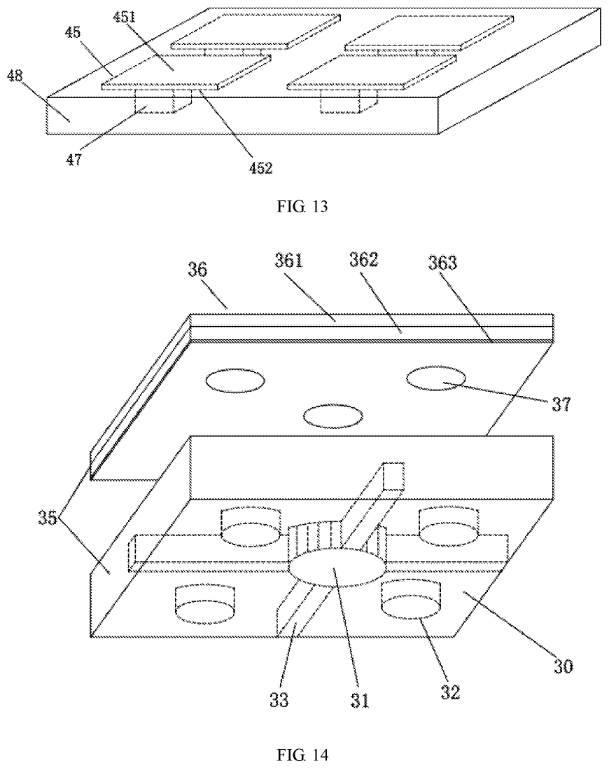

(1) Cooling-heating panel layer 48: as shown in FIG. 13, a plurality of semiconductor cooling-heating panels 45 and cooling fans 47 are arranged in the cooling-heating panel layer 48 and are electrically connected to a fourth sub-controller. Each semiconductor cooling-heating panel 45 has a heating face 452 and a cooling face 451, and each cooling fan 47 is arranged on one side of the heating face 452 of one semiconductor cooling-heating panel 45.

The heating faces 452 of the semiconductor cooling-heating panels 45 all face the upper surface or the lower surface of the cooling-heating panel layer 48, and the cooling faces 451 of the semiconductor cooling-heating panels 45 all face the other surface of the cooling-heating panel layer 48. When a cooling function is needed, the fourth sub-controller controls and selects the cooling function and starts the cooling fans 47. When a heating function is needed, the fourth sub-controller controls and selects the heating function and stops the cooling fans 47.

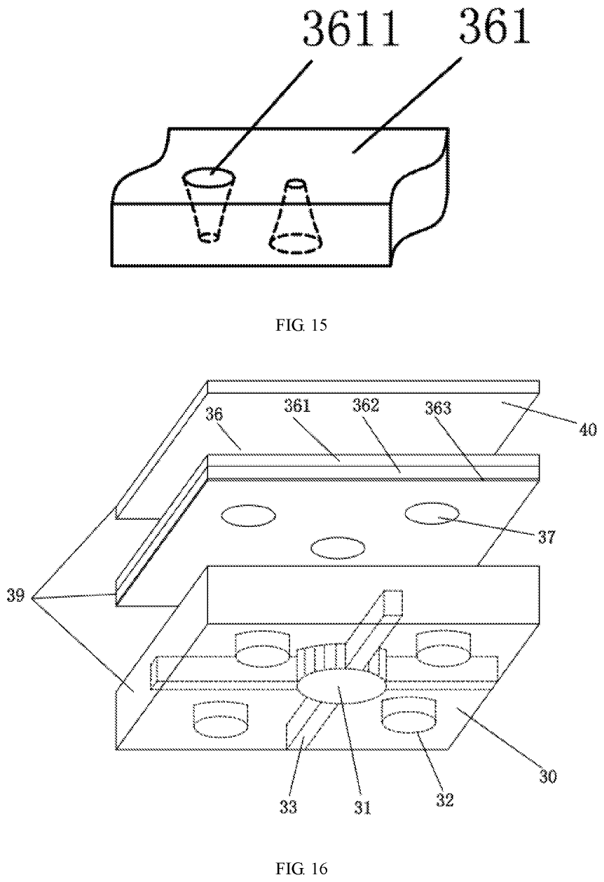

(2) Multifunctional pneumatic layer 35: as shown in FIG. 14 and FIG. 15, the multifunctional pneumatic layer 35 comprises a fan layer 30 and an air multiplication layer 36, that is, exhaust fans 31 and convection fans 32 are disposed in the multifunctional pneumatic layer 35 and can be arranged with reference to the above-mentioned fan layer 30. The air multiplication layer 36 is arranged over the fan layer 30, and the periphery of the air multiplication layer 36 is sealed. The air multiplication layer 36 has an upper layer 361, a middle layer 362 and a bottom layer 363, wherein the upper layer 361 is formed with multiple circular concave vortex air holes 3611, the middle layer 362 is of a hollow structure and is internally provided with support springs 34, and the bottom layer 363 is impermeable and has multiple fan ports 37 allowing an airflow from the fan layer 30 to flow through.

(3) Multifunctional cooling-heating layer 39: as shown in FIG. 16, the multifunctional cooling-heating layer 39 comprises a heating layer 40 and a multifunctional pneumatic layer 35, wherein the heating layer 40 is arranged over the multifunctional pneumatic layer 35, that is, the exhaust fans 31, the convection fans 32 and the air multiplication layer 36 are arranged in the multifunctional cooling-heating layer 39 in a manner similar to the multifunctional pneumatic layer 35, and a heating device 40 is arranged over the air multiplication layer 36.

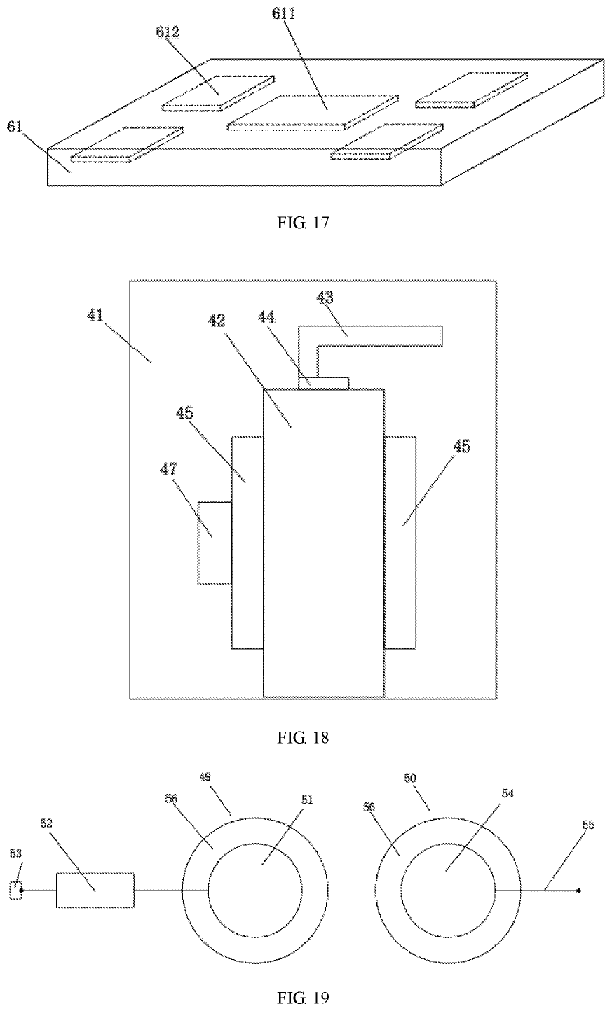

(4) Multifunctional health-care layer 61: as shown in FIG. 17, graphene physiotherapy lamellae 611 or massage lamellae 612 are arranged in the multifunctional health-care layer 61 and are electrically connected to a fifth sub-controller. The graphene physiotherapy lamellae 611 and the massage lamellae 612 are all arranged on upper surface of the multifunctional health-care layer 61 and are distributed at random. Or, the graphene physiotherapy lamellae 611 and the massage lamellae 612 are respectively arranged on the upper surface and the lower surface of the multifunctional health-care layer 61 and can be switched by turning the multifunctional health-care layer 61. The massage lamellae 612 may be current pulse massage devices.

The functional layer 1 can be used in combination with a plurality of independent devices such as a humid air supply device 41 and/or a sterilization device, wherein the humid air supply device 41 or the sterilization device is in signal communication with the master controller. The independent devices are arranged on one side of the human body safety support frame 6 or the external support 4, and can be connected to the intelligent mattress by means of telescopic rods.

(1) Humid air supply device 41: as shown in FIG. 18, the humid air supply device 41 comprises a liquid container 42, a semiconductor cooling-heating panel 45 and an air transport pipeline 43, wherein liquid is contained in the liquid container 42, an outlet 44 is formed in one end of the liquid container 42, the semiconductor cooling-heating panel 45 encircles the liquid container 42 and has a heating face 451 and a cooling face 452 (see FIG. 13), one part of the cooling face of the semiconductor cooling-heating panel 45 faces the liquid container 42, and one part of the heating face of the semiconductor cooling-heating panel 45 faces the liquid container 42. A cooling fan 47 is arranged on the heating face 451 of the semiconductor cooling-heating panel 45 with the cooling face facing the liquid container 42. One end of the air transport pipeline 43 is connected to the outlet 44, and the other end of the air transport pipeline 43 is divided into a plurality of branch pipelines to be connected to the air passages 33 of the fan layer 30, the multifunctional cooling-heating layer 39, or the multifunctional pneumatic layer 35.

The humid air supply device 41 further comprises a water level sensor and a temperature sensor, wherein the water level sensor and the temperature sensor are in signal communication with the master controller, the water level sensor is used for detecting water level information of the liquid in the liquid container, and the temperature sensor is used for detecting temperature information of the liquid in the liquid container and an airflow generated.

(2) The sterilization device may be an ultraviolet sterilization lamp, specifically.

Combined Usage of the Functional Layers:

(1) The pneumatic buffer layer 29 and the induction layer 38 can be used in combination with the multifunctional cooling-heating layer 39, the multifunctional health-care layer 61, or the cooling-heating panel layer 48, wherein the pneumatic buffer layer 29 is arranged over the multifunctional cooling-heating layer 39, the multifunctional health-care layer 61, or the cooling-heating panel layer 48;

(2) The multifunctional cooling-heating layer 39 or the multifunctional pneumatic layer 35 can be used in combination with the cooling-heating panel layer 48;

(3) The multifunctional cooling-heating layer 39 or the multifunctional pneumatic layer 35 can be used in combination with the humid air supply device 41;

(4) The cooling-heating panel layer 48 can be used in combination with the heating layer 40.

The functional layers 1 are fixedly connected by means of hook-and-loop fasteners, magnetic buckles, or hidden buckles, wherein the magnetic buckles are magnets, and the functional layers 1 are attracted together by means of the magnets. When the functional layers 1 are combined for use, anti-skid devices are arranged between the functional layers 1, and the anti-skid devices are made of flexible and elastic materials and are used for skid prevention and shock absorption.

Safety devices are arranged outside the inner layers of all functional layers 1 comprising electrical devices and are used for packaging the devices in the inner layers to fulfill fixing and protection effects, and the safety devices may be non-closed structures such as support nets.

The control system comprises an operating terminal and controllers. The operating terminal is one or more of a mobile phone, a computer mobile terminal, a wireless remote controller, a touch screen, a wireless headset and a wireless watch, and is used for providing an external operating interface to allow users to send control instructions to the intelligent mattress by controlling the operating terminal. The controllers are electrically or wirelessly connected to the operating terminal. The operating terminal is arranged on the side face of the intelligent mattress or is arranged independent of a body of the intelligent mattress, and is used for receiving the control instructions.

The controllers include a master controller and sub-controllers. The sub-controllers are arranged in the functional layers, are electrically or wirelessly connected to the operating terminal to receive control signals from the operating terminal, and are electrically connected to the electrical devices in the functional layers to control the devices. The master controller is arranged in the operating terminal and is in signal communication with the sub-controllers.

One or more of Bluetooth modules, 2.4G modules, mobile signal modules, WIFI signal modules and voice control modules are arranged in the master controller and the sub-controllers, and one or more of a Bluetooth module, a 2.4G module, a mobile signal module, a WIFI signal module and a voice control module matched with the master controller are arranged in the operating terminal.

The intelligent mattress acquires control instructions from users in the following ways:

(1) Voice control (direct control): the voice control modules of the controllers extract and recognize voice information and then convert the voice information into control instructions from users.

(2) Wireless-connection control based on the operating terminal (indirect control): each sub-controller is provided with a wireless transmission module such as the Bluetooth module or the WIFI module, and is connected to the master controller in the operating terminal through the wireless transmission module, and users can control on-off of the intelligent mattress and other functional instructions of the intelligent mattress in a wireless connection manner by means of the operating terminal;

(3) Wired-connection control based on the operating terminal (indirect control): each sub-controller is electrically connected to the operating terminal, and users directly control on-off of the intelligent mattress and other functional instructions of the intelligent mattress by means of buttons or a touch screen arranged on the operating terminal.

In the case of being wirelessly connected to the functional layer 1, the operating terminal comprises a microphone device, a loudspeaker device and a displayer, wherein the microphone device is provided with a voice control chip and is used for receiving external voice control instructions, the loudspeaker device is used for playing voice messages, and the displayer is used for displaying the operating state of the intelligent mattress.

The functional layer is provided with a power supply system, wherein the power supply system comprises a power supply device arranged on the side face of the human body safety support frame and is one or more of a battery system, an AC power supply system, a solar power supply system and an adsorptive human body safety magnetic-induction power supply system.

The solar power supply system comprises a solar power supply panel, which is electrically connected to a power unit and is arranged in a groove in the side face of the intelligent mattress. The solar power supply panel may be formed by connecting multiple solar panels of the same specification or of different specifications and shapes, can be unfolded when used, and can be folded to be received in the groove in the side face of the intelligent mattress when not used.

As shown in FIG. 19, the adsorptive human body safety magnetic-induction power supply system comprises a transmitting magnetic-induction power supply device 49 and an incoming magnetic-induction power supply device 50, wherein the incoming magnetic-induction power supply device 50 is arranged on the side face of the functional layer 1; the transmitting magnetic-induction power supply device 49 is arranged on the human body safety support layer 5, corresponds to the incoming magnetic-induction power supply device 50, and comprises a transmitting induction zone 51 with a transmitting coil, and the transmitting induction zone 51 is electrically connected to a power supply 53 through a current step-down device 52; the incoming magnetic-induction power supply device 50 comprises an incoming induction zone 54 with an incoming coil, and the incoming induction zone 54 supplies power to the electrical devices in the functional layer 1 by means of a power transmission line 55; and magnetic adsorption zones 56 are arranged around the transmitting induction zone 51 and the incoming induction zone 54, and magnet devices are arranged in the magnetic adsorption zones 56.

The incoming magnetic-induction power supply device 50 is arranged on the surface of the functional layer 1, and the transmitting magnetic-induction power supply device 49 is arranged on the surface of the human body safety support layer, corresponds to the incoming magnetic-induction power supply device in position, and can perform adsorptive charging. For example, the incoming magnetic-induction power supply device 50 is arranged on the lower surface of the functional layer 1, and the transmitting magnetic-induction power supply device 49 is arranged on the upper surface of the human body safety support layer; or, the incoming magnetic-induction power supply device 50 is arranged on the side face of the functional layer 1, and the transmitting magnetic-induction power supply device 49 is arranged on the same side face as the functional layer 1 of the human body safety support layer.

When the incoming magnetic-induction power supply device 50 and the transmitting magnetic-induction power supply device 49 are arranged at corresponding positions of the functional layer 1 and the human body safety support layer 5, alternate inductive power supply to multiple functional layers can be realized. For example, in the case where two functional layers, namely a first functional layer and a second functional layer, are connected to the human body safety support layer 5 in such a manner that the first functional layer is arranged on the upper surface of the human body safety support layer 5, that the second functional layer is arranged on the lower surface of the human body safety support layer 5, and that the two functional layers are electrically connected, the incoming magnetic-induction power supply device 50 in the first functional layer supplies power to the second functional layer, the incoming magnetic-induction power supply device 50 in the second functional layer supplies power to the first functional layer. The first functional layer and the second functional layer can be turned to adjust their positions on the human body safety support layer 5 so as to change the power supply relation, and the connection relations of the first and second functional layers with the induction power supply devices on the human body safety support layer are changed accordingly to allow the two functional layers to be charged by each other, thus realizing alternate inductive power supply.

### Embodiment 2

A multifunctional intelligent mattress in this embodiment differs from the multifunctional intelligent mattress in Embodiment 1 in that: the turning support structure comprises a support arm, wherein the support arm is a linear support arm or an L-shaped support arm, a head end of the support arm is pivoted to an edge of the human body safety support frame 6, and a tail end, opposite to the head end, of the support arm is pivoted to the external support 4.

The support arm is able to turn, with the head end of the support arm as an axis, by 90° or 180° in a direction perpendicular to the edge, to which the head end of the support arm is connected, of the human body safety support layer to switch the function layer to the hidden state or the exposed state;

Or, the support arm allows the functional layer to turn, with the tail end of the support arm as an axis, by 180° in a direction perpendicular or parallel to the edge, to which the head end of the support arm is connected, of the human body safety support layer. An illustration is given below:

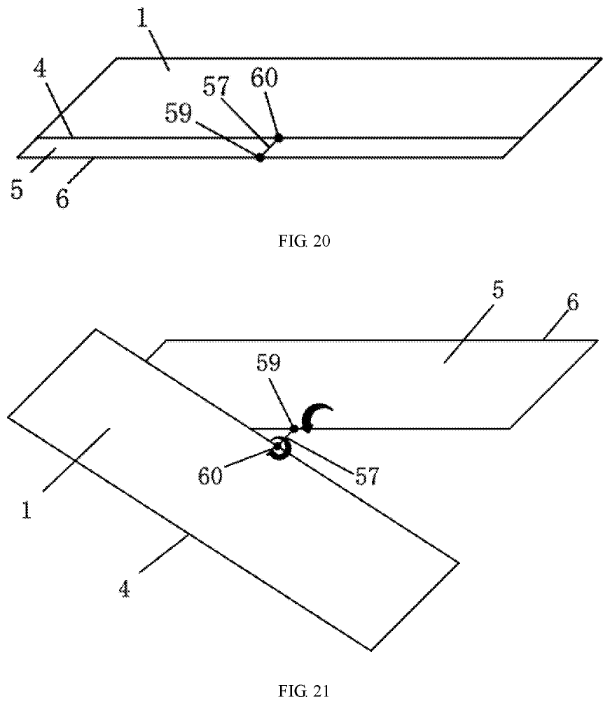

(1) For example, as shown in FIG. 20 and FIG. 21, when the support arm is a linear support arm 57, the head end 59 of the support arm is pivoted to the human body safety support frame 6, and the tail end 60 of the support arm is connected to the external support 4; and linear support arm 57 is able to turn, with the head end 59 of the support arm as an axis, by 90° or 180° in a direction perpendicular to an edge, to which the head end 59 of the support arm is connected, of the human body safety support frame 6 to switch the functional layer 1 to the hidden state or the exposed state. That is, the functional layer 1 in the figure is allowed to turn forwards or backwards.

Or, the linear support arm 57 allows the functional layer to turn, with the tail end 60 of the support arm as an axis, by 180° in a direction perpendicular or parallel to an edge, to which the head end 59 of the support arm is connected, of the human body safety support frame 6. That is, the functional layer 1 in the figure is allowed to turn leftwards or rightwards.

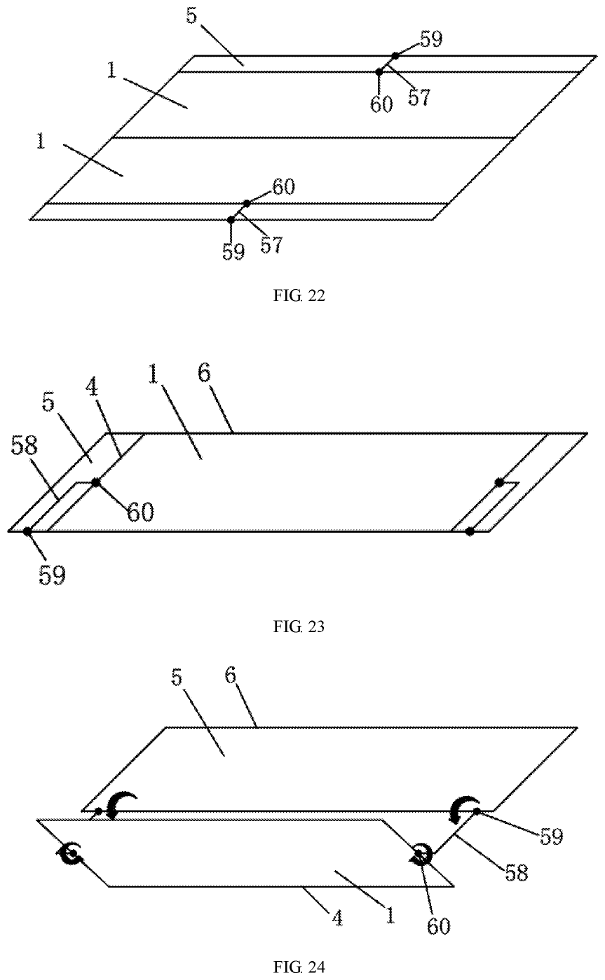

One or more functional layers 1 may be fixed on the human body safety support layer 5. For example, in the case of two functional layers 1, the two functional layers 1 can be arranged side by side, as shown in FIG. 22, to meet the requirements of different users sharing a double bed. Or, the two functional layers 1 can be arranged in an overlapped manner.

(2) For another example, as shown in FIG. 23 and FIG. 24, when the support arm is an L-shaped support arm 58, the head end of the support arm 59 is pivoted to the human body safety support frame 6, and the tail end 60 of the support arm is pivoted to the external support 4; and the L-shaped support arm 58 is able to turn, with the head end 59 of the support arm as an axis, by 90° or 180° in a direction perpendicular to an edge, to which the head end 59 of the support arm is connected, of the human body safety support frame 6 to switch the functional layer 1 to the hidden state or the exposed state. That is, the functional layer 1 in the figure is allowed to turn forwards or backwards.

Or, the L-shaped support arm 58 allows the functional layer 1 to turn, with the tail end 60 of the support arm as an axis, by 180° in a direction perpendicular or parallel to an edge, to which the head end 59 of the support arm is connected, of the human body safety support frame 6. That is, the functional layer 1 in the figure is allowed to turn leftwards or rightwards.

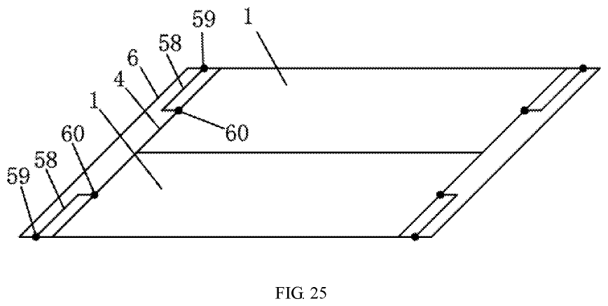

One or more functional layers 1 may be fixed on the human body safety support layer 5. For example, in the case of two functional layers 1, the two functional layers 1 can be arranged side by side, as shown in FIG. 25, to meet the requirements of different users sharing a double bed. Or, the two functional layers 1 can be arranged in an overlapped manner.

Although the embodiments of the present invention have been illustrated and described above, those commonly skilled in the art can make various changes, modifications, substitutions and transformations to these embodiments without departing from the principle and spirit of the present invention. The scope of the present invention is defined by the appended claims and their equivalents.

What is claimed is:

1. A multifunctional intelligent mattress, comprising
a functional layer, a turning device, a control system and a power supply system;
wherein
the turning device is configured for fixing and turning the functional layer;
the functional layer has an inner layer and an outer layer;
the inner layer comprises a plurality of functional devices, and the outer layer is a breathable textile fabric;
an external support is arranged on an edge of an outer surface of the functional layer and the external support is configured for fixing and connecting the functional layer and the turning device;
the turning device comprises a human body safety support layer and a turning mechanism;
the human body safety support layer is configured for supporting the functional layer;
a human body safety support frame is arranged on an outer surface of the human body safety support layer and the human body safety support frame is configured for fixing and connecting the human body safety support layer;
the functional layer has a hidden state and an exposed state;
in the exposed state, the functional layer is located on an upper surface of the human body safety support layer, and a front side of the functional layer faces upwards;
in the hidden state, the functional layer is located below the human body safety support layer or on the upper surface of the human body safety support layer, and the front side of the functional layer faces downwards;
the functional layer is turned by the turning mechanism to be switched to the hidden state or the exposed state;
the turning mechanism is a turning slide-rail structure or a turning support structure;
the control system is configured for controlling the multifunctional intelligent mattress according to an external instruction and the control system comprises controllers and an operating terminal; wherein
the controllers comprise a master controller and sub-controllers;
the master controller is in a signal communication with the sub-controllers disposed in the functional layer, and the master controller is arranged in the operating terminal;
the operating terminal is configured for receiving an external control instruction, and the power supply system is configured for supplying power to the multifunctional intelligent mattress.

2. The multifunctional intelligent mattress according to claim 1, wherein
the turning slide-rail structure comprises two sets of slideways; wherein
the two sets of slideways are parallel to each other;
each set of slideways of the two sets of slideways comprise a main slideway, a plurality of sub-slideways and a bottom slideway; wherein
the plurality of sub-slideways comprising a first sub-slideway, a second sub-slideway, . . . and an n^{th} sub-slideway are sequentially arranged below the main slideway;
the bottom slideway is located at a bottom of the plurality of sub-slideways;
the human body safety support layer is fixed between a lower surface of the main slideway and an upper surface of the first sub-slideway;
the main slideway and the plurality of sub-slideways are located on one vertical plane and are horizontal;
two ends of the main slideway are aligned with two ends of each sub-slideway of the plurality of sub-slideways;
a head end of the main slideway and head ends of the plurality of sub-slideways are connected by connecting slideways;
a first sealing device is arranged at a tail end of the main slideway opposite to the head end of the main slideway, and second sealing devices are arranged at tail ends of the plurality of sub-slideways opposite to the head ends of the plurality of sub-slideways;
the connecting slideways have a closed state and an open state;
when the connecting slideways are closed, the main slideway is connected to the plurality of sub-slideways;
when the connecting slideways are opened, the main slideway is disconnected from the plurality of sub-slideways;
sliding wheels matched with the main slideway, the plurality of sub-slideways and the bottom slideway are arranged on the external support, and the functional layer is configured to slide and turn along the main slideway and the plurality of sub-slideways by the sliding wheels;
the functional layer is arranged between two sub-slideways of the plurality of sub-slideways or the functional layer is arranged between the n^{th} sub-slideway and the bottom slideway, and the functional layer is configured to slide and turn along the main slideway and the plurality of sub-slideways to be switched to the hidden state or the exposed state.

3. The multifunctional intelligent mattress according to claim 1, wherein
the turning support structure comprises a support arm, and the support arm is a linear support arm or an L-shaped support arm;
a head end of the support arm is pivoted to an edge of the human body safety support frame, and a tail end, opposite to the head end, of the support arm is pivoted to the external support;
the support arm is configured to turn, with the head end of the support arm as a first axis, by 90° or 180° in a direction perpendicular to the edge of the human body safety support frame, wherein the head end of the support arm is connected to the edge of the human body safety support frame; or
the support arm allows the functional layer to turn, with the tail end of the support arm as a second axis, by 180° in a direction perpendicular or parallel to the edge of the human body safety support frame.

4. The multifunctional intelligent mattress according to claim 1, wherein
the functional layer comprises a single functional layer and/or a complex functional layer;
the single functional layer is one selected from the group consisting of an induction layer, a heating layer, a fan layer and a pneumatic buffer layer;
a temperature sensor and a pressure sensor are arranged in the induction layer and are electrically connected to a first sub-controller of the sub-controllers;
a heating device is arranged in the heating layer and the heating device is electrically connected to a second sub-controller of the sub-controllers;
an exhaust fan and a convection fan are arranged in the fan layer and are electrically connected to a third sub-controller of the sub-controllers;
a buffer spring is arranged in the pneumatic buffer layer, and both an interior and an exterior of the pneumatic buffer layer are breathable;
the complex functional layer is one selected from the group consisting of a cooling-heating panel layer, a multifunctional pneumatic layer, a multifunctional cooling-heating layer, and a multifunctional health-care layer; wherein
a first semiconductor cooling-heating panel and a cooling fan are arranged in the cooling-heating panel layer and are electrically connected to a fourth sub-controller of the sub-controllers;
the first semiconductor cooling-heating panel has a heating face and a cooling face, and the cooling fan is arranged on a side of the heating face of the first semiconductor cooling-heating panel;
the multifunctional pneumatic layer comprises the fan layer and an air amplification layer arranged over the fan layer;
a periphery of the air multiplication layer is sealed;
the air multiplication layer has an upper layer, a middle layer and a bottom layer;
the upper layer is provided with a plurality of circular concave vortex air holes, the middle layer is a hollow structure and the middle layer is internally provided with a support spring, and the bottom layer is impermeable and the bottom layer has a plurality of fan ports, wherein an airflow from the fan layer flows through the plurality of fan ports;
the multifunctional cooling-heating layer comprises the heating layer and the multifunctional pneumatic layer;
the multifunctional health-care layer is provided with a graphene physiotherapy lamella or a massage lamella, and the graphene physiotherapy lamella or the massage lamella is electrically connected to a fifth sub-controller of the sub-controllers;
the single functional layer and the complex functional layer work in combination with a plurality of independent devices, wherein the plurality of independent devices comprise a humid air supply device and/or a sterilization device, the plurality of independent devices are arranged on a side of the human body safety support frame or the external support, and the humid air supply device and/or the sterilization device are/is in a signal communication with the master controller;
the single functional layer and the complex functional layer work cooperatively, wherein the pneumatic buffer layer and the induction layer work combination with the multifunctional cooling-heating layer, the multifunctional health-care layer, or the cooling-heating panel layer;
the multifunctional pneumatic layer works in combination with the cooling-heating panel layer;
the multifunctional cooling-heating layer or the multifunctional pneumatic layer works in combination with the humid air supply device; and
the cooling-heating panel layer works in combination with the heating layer.

5. The multifunctional intelligent mattress according to claim 4, wherein
the exhaust fan is configured for extracting air above the exhaust fan and discharging the air above the exhaust fan to a peripheral side of the exhaust fan, or the exhaust fan is configured for extracting air around the exhaust fan and discharging the air around the exhaust fan upwards;
the convection fan is configured for extracting air above the convection fan and discharging the air above the convection fan downwards, or the convection fan is configured for extracting air below the convection fan and discharging the air below the convection fan upwards;
the exhaust fan and the convection fan are arranged in a staggered manner, and air passages are formed in a periphery of the exhaust fan and extend to side faces of the fan layer.

6. The multifunctional intelligent mattress according to claim 4, wherein
a plurality of semiconductor cooling-heating panels are arranged in the cooling-heating panel layer;
each semiconductor cooling-heating panel of the plurality of semiconductor cooling-heating panels has a heating face and a cooling face;
the cooling fan is arranged on a side of the heating face of the each semiconductor cooling-heating panel;
the heating face of the each semiconductor cooling-heating panel faces one of an upper surface and a lower surface of the cooling-heating panel layer; and
the cooling face of the each semiconductor cooling-heating panel faces the other one of the upper surface and the lower surface of the cooling-heating panel layer.

7. The multifunctional intelligent mattress according to claim 4, wherein
the humid air supply device comprises a liquid container, a second semiconductor cooling-heating panel and an air transport pipeline;
the second semiconductor cooling-heating panel is in a signal communication with the master controller;
a liquid is contained in the liquid container, an outlet is formed in an end of the liquid container, and the second semiconductor cooling-heating panel encircles the liquid container;
the second semiconductor cooling-heating panel has a heating face and a cooling face arranged separately, and the cooling fan is arranged on a side of the heating face; and
the air transport pipeline has an end connected to the outlet and an end divided into a plurality of branch pipelines, wherein the plurality of branch pipelines are connected to air passages of one of the fan layer, the multifunctional cooling-heating layer, and the multifunctional pneumatic layer.

8. The multifunctional intelligent mattress according to claim 7, wherein
the humid air supply device further comprises a water level sensor and a temperature sensor, wherein the water level sensor and the temperature sensor are in a signal communication with the master controller,
the water level sensor is configured for detecting water level information of the liquid in the liquid container, and the temperature sensor is configured for detecting temperature information of the liquid in the liquid container and a generated airflow.

9. The multifunctional intelligent mattress according to claim 4, wherein
a temperature isolation device is arranged in the induction layer, the temperature isolation device is located below a sensing part of the temperature sensor, and the temperature isolation device is configured for isolating the sensing part located above the temperature isolation device of the temperature sensor from an airflow below the temperature isolation device.

10. The multifunctional intelligent mattress according to claim 9, wherein
a through hole is formed in the temperature isolation device, and the sensing part of the temperature sensor extends to an upper surface of the induction layer via the through hole.

11. The multifunctional intelligent mattress according to claim 4, wherein
the master controller is electrically or wirelessly connected to the sub-controllers to receive control signals from the sub-controllers and control the temperature sensor, the pressure sensor, the heating device, the exhaust fan, the convection fan, the first semiconductor cooling-heating panel, the cooling fan, the graphene physiotherapy lamella and the massage lamella in the single functional layer and the complex functional layer.

12. The multifunctional intelligent mattress according to claim 4, wherein
when the operating terminal is wirelessly connected to the functional layer, the operating terminal comprises a microphone device, a loudspeaker device and a displayer;
the microphone device is provided with a voice control chip and the microphone device is configured for receiving external voice control instructions;
the loudspeaker device is configured for playing voice messages; and
the displayer is configured for displaying an operating state of the multifunctional intelligent mattress.

13. The multifunctional intelligent mattress according to claim 4, wherein
the induction layer further comprises a humidity sensor, wherein the humidity sensor is arranged on an upper surface of the induction layer and the humidity sensor is electrically connected to the first sub-controller.

14. The multifunctional intelligent mattress according to claim 13, wherein
the first sub-controller comprises a safety recognition module, wherein the safety recognition module is configured for determining whether a user of the multifunctional intelligent mattress is in a safe condition by the temperature sensor and the humidity sensor;
the temperature sensor is configured for detecting temperature data in real time and determining whether the temperature data is within a temperature safety range; and
the humidity sensor is configured for detecting humidity data in real time and determining whether the humidity data is within a humidity safety range.

15. The multifunctional intelligent mattress according to claim 4, wherein
the first sub-controller comprises a self-start recognition module, wherein the self-start recognition module comprises a pressure recognition module and an infrared induction module;
the pressure recognition module is automatically started when determining that a user is adjacent to or is located on the multifunctional intelligent mattress according to pressure data detected in real time by the pressure sensor in the induction layer;
the pressure recognition module is automatically stopped when determining that the user leaves the multifunctional intelligent mattress;
the infrared induction module comprises an infrared sensor, wherein the infrared sensor is arranged on a side of the induction layer and the infrared sensor is electrically connected to the first sub-controller;
the infrared induction module is automatically started when determining that the user is adjacent to or is located on the multifunctional intelligent mattress according to data detected in real time by the infrared sensor; and
the infrared induction module is automatically stopped when determining that the user leaves the multifunctional intelligent mattress.

16. The multifunctional intelligent mattress according to claim 4, wherein
a vibrating device and a timing device are arranged in the pneumatic buffer layer and are electrically controlled to a sixth sub-controller of the sub-controllers, and the sixth controller comprises an intelligent wake-up module, wherein the intelligent wake-up module is configured for controlling the vibrating device to vibrate at a time set by the timing device.

17. The multifunctional intelligent mattress according to claim 4, wherein
the power supply system comprises a power supply device arranged on a side face of the human body safety support device, and the power supply system is one or more selected from the group consisting of a battery system, an AC power supply system, a solar power supply system and an adsorptive human body safety magnetic-induction power supply system.

18. The multifunctional intelligent mattress according to claim 17, wherein
the solar power supply system comprises a solar power supply panel, wherein the solar power supply panel is electrically connected to a power unit, and the solar power supply panel is arranged in a groove in a side face of the multifunctional intelligent mattress.

19. The multifunctional intelligent mattress according to claim 17, wherein
the adsorptive human body safety magnetic-induction power supply system comprises a transmitting magnetic-induction power supply device and an incoming magnetic-induction power supply device;
the incoming magnetic-induction power supply device is arranged on a side face of the functional layer;
the transmitting magnetic-induction power supply device is arranged on the human body safety support layer, the transmitting magnetic-induction power supply device corresponds to the incoming magnetic-induction power supply device, and the transmitting magnetic-induction power supply device comprises a transmitting induction zone with a transmitting coil; wherein
the transmitting induction zone is electrically connected to a power supply through a current step-down device;
the incoming magnetic-induction power supply device comprises an incoming induction zone with an incoming coil, and the incoming induction zone supplies power to electrical devices in the functional layer by a power transmission line; and
magnetic adsorption zones are arranged around the transmitting induction zone and the incoming induction zone, and magnet devices are arranged in the magnetic adsorption zones.

20. The multifunctional intelligent mattress according to claim 19, wherein
the incoming magnetic-induction power supply device and the transmitting magnetic-induction power supply device are arranged at positions corresponding to the functional layer and the human body safety support layer to alternately supply the power to the single functional layer and the complex functional layer inductively.
